(19) United States
(12) Patent Application Publication
(10) Pub. No.: US 2014/0258172 A1
(43) Pub. Date: Sep. 11, 2014

(54) METHOD AND SYSTEM FOR THE DISCOVERY AND DESCRIPTION OF BUSINESS ENDEAVOURS

(71) Applicant: Terence Malcolm Roach, Sydney (AU)

(72) Inventor: Terence Malcolm Roach, Sydney (AU)

(21) Appl. No.: 13/862,376

(22) Filed: Apr. 12, 2013

Related U.S. Application Data
(60) Provisional application No. 61/625,067, filed on Apr. 16, 2012.

(51) Int. Cl. G06Q 10/06

(52) U.S. Cl. CPC G06Q 10/067
USPC 705/348

(57) ABSTRACT

A key ingredient in the design and development of enterprise software systems is a precise description of the business endeavour. In practice the engineering designs for corporate systems are surprisingly poorly articulated due to the difficulty organisations face in clearly defining their business needs in a structured and unambiguous manner. One problem is that the notations used in business process specifications are technical in nature, notoriously complex and not particularly intelligible to business stakeholders. Further, since the business environment is highly dynamic, static documentation is quickly out-of-date and rarely reusable beyond the lifespan of any particular project. There is a constant disconnect between the fluid, evolving nature of business strategies and the brittle, rigid nature of process automation. As a consequence, business stakeholders have little direct control over the structure, behaviour and governance of information systems, which is a major contributing factor in the pervasive issue of system inflexibility and adaptability. This invention provides a method and corresponding system design for addressing these limitations by articulating a business endeavour in a comprehensive, structured conceptual model that is independent of underlying technology and responsive to the dynamics of business strategy.

### CROSS REFERENCE TO RELATED PATENT APPLICATIONS

This application claims benefit of U.S. Provisional Patent Application No. 61/625,067 filed on 16 Apr. 2012

### STATEMENT REGARDING FEDERALLY SPONSORED RESEARCH OR DEVELOPMENT

Not Applicable

### REFERENCE TO A SEQUENCE LISTING, A TABLE, OR A COMPUTER PROGRAM, LISTING COMPACT DISC APPENDIX

Not Applicable

### BACKGROUND OF THE INVENTION

The present disclosure relates to information technology management and more particularly to providing reliability and precision in the definition of a business endeavour.

Information technology (IT) has the potential to transform entire industries. In many cases, the use of information technology defines the nature of a business. However, the usefulness of IT systems depends crucially on how well IT investments are aligned with business strategies. This alignment requires that both sides of the partnership between business strategy and IT enablement be defined and described with similar precision, and at comparable levels of granularity.

As ‘suppliers’ of information systems, the IT team of an enterprise are tasked with delivering technology-based automation to make the business more efficient, and are measured by the quality of the systems that they provide to the business. To get an overall perspective of how the systems link and flow together, they create detailed charts, maps and diagrams which together comprise an Enterprise Architecture. The Enterprise Architecture is used to describe, govern and manage the automated systems.

The discipline of Enterprise Architecture, while not yet fully mature, has seen major progress over the past two decades. Theories have been elaborated, and methods developed to guide and support the work of practitioners. At the cost of some considerable effort, it is now possible to prepare and maintain effective models of the automated parts of an enterprise. Yet Enterprise Architecture design is rooted in imprecision inasmuch as the essential motivation for its existence is not established with similar clarity and precision.

The ‘consumers’ of enterprise information systems are the business stakeholders, who are tasked with managing and executing business initiatives that realise strategic goals, and are measured by their achievement of business outcomes. Information systems are simply tools to make them more efficient in the execution of their activities.

To fully realise its benefits, Enterprise Architecture must include a constituent Business Architecture, defined, governed and managed with a precision and clarity similar to those available for the technical constituents. This is not currently the case. While several theories of business organisation are extant, there is no systematic approach to the discovery, analysis and definition of the architecture of a whole business endeavour.

The issue of one of alignment. Whilst effective business strategies are naturally fluid and adaptable digital automation is, by necessity, entirely structured. Inherent in the definition of a system specification is a process of imposing structure on the unstructured. The flexibility inherent in a business endeavour will entail important questions of coupling, composability, scope and boundary specifications in a system design, yet the articulation of these in business requirements is generally haphazard and sporadic.

One core issue in doing so is that of vocabulary. Without common understanding and precise agreement on the concepts and terminology required to adequately compose a business description, it is little wonder that there is great difficulty in constructing computer systems that adequately automate a business.

Accordingly, there is a need for a system and method for the discovery and precise description of business endeavours.

### BRIEF DESCRIPTION OF THE INVENTION

One embodiment of the invention includes a foundation ontology of business endeavour. This ontology establishes a controlled vocabulary of terms relative to concerns relevant to the construction and operation of a business endeavour, a specification of the expected relationships among said concerns, and a theory of the functioning of a business based on the defined terms.

Another embodiment of the invention includes a computer system for the recording of business definitions in the form of ontologies based on the foundation ontology. This computer system includes an ontology store and a reasoning engine capable of generating entry forms to guide the definition of individual business objects, relationships and rules.

This system includes a variety of input methods, ranging from importing prepared tables and diagrams to interactive editing of ontologies. The system also includes several forms of validation of input information, to ensure the logical integrity of the ontologies. The system further includes several visualisation methods, the purpose of which is to present the recorded knowledge as “views” which are suited to the variety of stakeholders, with the purpose of verifying the factual integrity of input information.

Another embodiment of the invention includes a method for the orderly discovery of business definitions, based on the theory of Business Architecture represented by the foundation ontology. The discovery can be guided by published directives and a standard process, or by the use of the computer system mentioned previously. It can be based on available documentation, such as use cases, formal process definitions and other artefacts currently considered part of Business Architecture descriptions.

Over and above such artefacts, the method introduces the verification of several levels of interdependencies. It also organises the discovered material in a framework which makes possible a rational factoring of the information into precisely identified domains, as well as specifying precisely the interactions among these domains.

Other systems, methods and/or computer program products according to embodiments will be or become apparent to persons with skills in the art upon review of the drawings and description contained in this disclosure. It is intended that all such additional systems, methods and/or computer program products be included within this description, be within the scope of the present invention, and be protected by the accompanying claims.

### DETAILED DESCRIPTION OF THE INVENTION

Exemplary embodiments, as shown and described by the various figures and the accompanying text, provide methods, systems and computer program products for using a foundation ontology as a driver for the acquisition, verification and management of enterprise knowledge. In an enterprise environment, such as a corporation, there may be many disparate domains of activity, the knowledge, understanding and mastery of which resides in a variety of documents, or even only in the awareness of certain persons. It is difficult to synthesise this enterprise knowledge in the absence of a unifying principle.

An ontology provides a formalised specification of relevant concepts, such as the objects on which the domain of endeavour operates, the agents who have power to effect such operations, the rules that apply to activities, and the interrelationships among all such elements. A foundation ontology is a model of the common elements that are generally applicable across a wide range of domain ontologies. It specifies the common structure and behaviour of such elements across the variety of domains.

In an embodiment, the foundation ontology informs, mandates and/or restricts the operations of a computer system which supports the operation and/or governance of a business endeavour. It may variously do so by:
driving the automatic creation of input forms for a documentation system;
driving a validating the acquisition of information by checking logical consistency;
specifying possible/mandatory dependencies between model items;
keeping track of unanswered requirements in an evolving model;
identifying integration points between model components.

The foundation ontology specifies the structure of a domain. In an embodiment, it guides the assignment of model elements to a specific domain, to ensure maximal domain cohesion and minimal inter-domain coupling.

The foundation ontology specifies the mechanism for integration of resources, actions a rules between domains. In an embodiment, it guides the appropriate mappings among elements of the models of each domain, to ensure:
that boundary elements are logically compatible;
that boundary elements correctly represent the subject matter of each domain;
that the representations support the appropriate expressive and/or reasoning power of the notation.

The foundation ontology specifies the mechanism for federation of domains. As domains are properly nested, considerations of cohesion and coupling are applied recursively when selecting which domains are to be grouped and incorporated in a higher scope. In an embodiment, the foundation ontology supports the definition of the hierarchy of domains.

The foundation ontology is a meta-model for the architecture of business endeavour. A business endeavour involves the deployment of resources in pursuit of desired results. Any business endeavour is assumed to be intentional, ie does not occur by chance and is conducted with the intent of achieving specific states-of-affairs for the resources it deploys. A typical business endeavour usually comprises multiple domains. Each domain represents a particular sphere of interest within the business scope; it is distinguished by common terminology, activities, and controls, relative to other domains in the business. Domain partitions factor the scope of the business into the discrete areas of endeavour addressed by each respective domain.

The dynamics of a domain endeavour (ie a business operation) are encompassed in the foundation ontology, comprised of 9 core business constructs and their relationships organised in a 2-dimensional matrix (as depicted in FIG. 2a).

The horizontal axis of the matrix organises the scope of operations of a business domain into 3 pillars, namely:
Structure—definitions for business concepts within the domain and their desired states-of-affairs;
Behaviour—mechanisms for state-transitions on instances of business objects;
Governance—axiomatic expressions that articulate and exercise business controls.

The vertical axis of the framework describes the enablement of operations in a business domain across 3 layers, namely:
Capacities—recognised parties authorised to participate in particular business interactions;
Capabilities—coordinated evolutions of the state of resources in pursuit of defined business outcomes;
Concepts—descriptions of the form, instances and material properties of resources deployed by the business.

A distinguishing feature of the three pillars is that they facilitate the decoupling of both the structural and behavioural models of the business endeavour from the controls that govern the enterprise.

The foundation ontology envisions an enterprise (and any of its constituent domains) as a recursive finite-state machine hierarchy. At any given moment, a domain is in a definite state-of-affairs, consisting of the then current states of each of its resource instances. Behaviour mechanisms evolve the state of a resource through transitions from one such state-of-affairs to another. A state transition is either triggered by an associated pre-condition or intentionally invoked by an interaction with an agent, either internal or external to the domain.

Typical process-oriented models incorporate tightly coupled rules and logic into a process specification. The complexity of a notation such as the Business Process Modelling Notation (BPMN) is a function of its concern with expressing all manner of complex business logic in combination with the statement of transitions. In effect, BPMN aspires to encompass both Behaviour and Governance logic within a single notation. Similarly the decision tables, decision trees and sequence diagrams of object-oriented models such as the Unified Modelling Language (UML), incorporate Governance logic into a single integrated Behaviour model. In both cases there is no recognition of the distinction between the execution of Behaviour and its Governance.

Object-oriented models are traditionally comprised of two types of models, dynamic (behavioural) and static (structural). Perhaps the most commonly used notation for object-oriented modelling is the OMG Unified Modelling Language (UML). UML models have two distinct views of a system, namely static (describes the things in the model that need to be defined, comprised of class diagrams and composite structure diagrams, amongst others) and dynamic (describes the system functionality, comprised of sequence diagrams, activity diagrams and state-machine diagrams, amongst others).

These two views are roughly representative of the foundation ontology models for Structure and Behaviour. A major distinction however is in the handling of Governance. Governance represents organisational control; managing decisions to meet expectations. In UML the controls expressed through business logic and constraints are embedded—explicitly or implicitly—in the models of the structural and behavioural views. Any changes to business policies or rules may have a myriad of implications across a multitude of object designs since the devices that implement business controls are buried in these models. This tendency to embed the complexity of business logic and constraints into the modelling notation is possibly the single biggest cause of the continuing frustration that business stakeholders have with the lack of flexibility of contemporary business applications.

Decoupling Governance from the Structural and Behaviour models promotes flexibility and adaptability by isolating the versatile elements of business Governance from the enduring, less mutable Behaviour patterns and Structural descriptions.
Consistent Structural descriptions exert universal semantic definitions for business terms in a controlled vocabulary, which is essential for interoperability.
Stable Behaviour patterns enforce repeatable practices that coordinate the manner in which business operations are consistently executed.
Parametric Governance directives expose dynamic business controls for flexible manipulation of Behaviour logic and Structural constraints.

In exemplary embodiments, the foundation ontology serves as a framework for “business intelligence” reporting. These reports are of two kinds:
Statistics about the constituents of the models
   General statistics: counts, cardinalities, branching indices, etc.
   Specific indices of quality: density of coupling, measures of diameter, etc.
Using reasoning based on such statistics, provision of guidance or advice on the development of the model (e.g., when to split a domain model).

In another embodiment, the foundation ontology is used to frame the generation of system requirements documents, by organising the mapping between the business architecture and the computer systems that will be designed to support it.

The foundation ontology constitutes the base layer of a knowledge stack which structures and separates diverse types of reasoning
Reasoning about the “domain of discourse” of business endeavour properly belongs in the foundation ontology, where generic concepts and their logical connections are described.
Reasoning about particular business endeavours belongs in the particular models constructed for each endeavour. By separating these models from the foundation ontology, it is possible to maintain an adequate descriptive power without incurring the possible inconsistencies of more powerful logics.

In exemplary embodiments of the invention the foundation ontology serves to guide the creation of model frameworks which are kept distinct from the foundation, while ensuring traceability between the two levels of reasoning.

Further embodiments of the invention may leverage the foundation ontology, as well as the particular domain ontologies arising from it, to support practical functions in a business endeavour, such as Management, Maintenance and Adaption.
Management of business resources (ERP) is a well-established discipline. However, there are major challenges to integrate it with both business architecture definition and business strategy elaboration. The framework provided by the foundation ontology makes it possible to bridge the gap between established ERP systems and methods and business architecture.
Similarly, Maintenance is often supported by self-contained systems. Integration of such systems can be achieved by using the foundation ontology.
Adaption is concerned with change to the business architecture, as necessitated by the need to adapt to a changing environment. The foundation ontology offers two lines of support:
   By modelling the changed environment as a set of domains, it supports the redefinition of business boundaries and interfaces, and consequently the repositioning of the business.
   It also provides the framework for the insertion of new domains (e.g., for new lines of business) or the removal of obsolete ones (“decommissioning”).

### EXPLANATION OF THE DRAWINGS

Turning now to the drawings, FIG. 1 depicts the way in which the foundation ontology organises the definition and description of a Business endeavour, by means of nine constructs.

Resource 111 (Things and their Properties)

Resources are the things that a business will mobilise to enable the achievement of Goals. Resource definitions describe the domain specific vocabulary of the business and form a language for the business endeavour. CAPSICUM takes a very broad definition of a Resource, which may include:
Physical artefacts such as Assets, Materials and Products;
Business records such as Quotes, Orders and Invoices;
Parties (People, Systems or groups) such as Individuals, Companies, Business Units;
Locations such as physical Places, Sites, Addresses;

Resources are defined as structured taxonomies of Classes organise the types of business objects within a Domain.

Resource properties are predicates of two possible types:
Attributes that identify information descriptors required to adequately describe a Resource.
Relations that identify how a Resource relates to other Resources
   Outcome 112 (Resources are evolvedBy Outcomes.)

Outcomes are states-of-affairs represented as patterns for specific states in the lifecycle of a Resource instance. Achievement of an Outcome results in the evolution of a Resource instance between possible states in its Outcome lifecycle. For example in the lifecycle of a SalesOrder Resource, possible Outcomes might include SalesOrder>Created, SalesOrder>Submitted, SalesOrder>Approved etc.

A Resource instance can only exist in one of its possible Outcome states; each Outcome is represented as a state pattern for the properties of a Resource. For example if an instance of a SalesOrder Resource has a property called hasApprover then the Outcome

SalesOrder>Approved describes the state where the property hasApprover has been validly instantiated.

Role 113 (Resources are capacitatedBy Roles and Outcomes are commitedBy Roles.)

A Role is a recognised capacity assigned to a party Resource (eg People or Systems). A Role designation represents the authority for a party to act in a particular business interaction. The result of a Role interaction commits a Resource to a particular Outcome.

A Role is not a property of a Resource, but rather is an association of a party Resource with the capacity to commit to a specific Outcome. It defines the required characteristics of a party Resource who may be designated the rights and responsibilities to participate in a specific interaction. A Resource may participate in many different interactions and therefore be capacitated by more than one Role at different times and in different interactions.

Role capacities are fluid and the capacity to commit a particular Outcome may be assigned to any Resource that satisfies the required Role Entitlement pattern.

Context 114 (Resources are instantiatedBy Context.)

Context represents the state-of-affairs of a Domain at any specific moment (the here and now). It is comprised of all Resource instances in a Domain in their particular Outcome states at that point in time. As the states of Resources transition and achieve new Outcomes, Context evolves to reflect this constant change in the state-of-affairs of the Domain. Each change to Context enables pre-conditions for relevant Undertakings to evolve Resources into subsequent Outcomes.

Whereas Resource definitions describe conceptual representations of things, Context represents actual instances of individual Resources in the Domain. However inasmuch as an individual is an instantiation of the structural form of a Resource, it is also an instantiation of the values of its properties. Property values are constrained by Compliance assertions, which govern the valid values for Attributes and Relations.

Resource instances are dynamic, that is, their properties can and do change over time. Accordingly Resource property values are dynamic and reflect the temporal condition of the Resource. The state of a Resource instance is reflected by its Context, which reflects the value of its properties at a given moment in time.

Undertaking 115 (Outcomes are achievedBy Undertakings)

Undertakings represent the discrete functional activities which evolve Resource instances in a business endeavour. Undertakings are organised into a hierarchical inventory—a taxonomy—of business Capabilities, where higher level Undertakings are comprised of more granular Undertakings at lower levels in the hierarchy. Each Undertaking is associated with a unique Outcome that it is designed to achieve.

Undertaking definitions identify the subject and object Resources involved in an activity and the Outcome pattern that the Undertaking is designed to achieve through state transitions of the associated Resources. The effect of a successful Undertaking on the associated Resources is to instantiate one or more of their properties.

For example the Undertaking approve>SalesOrder will attempt to execute an approval (a transition of state) of a SalesOrder by a Role (party Resource) for a Customer (subject Resource) relating to a Product (object Resource). If successful, the Undertaking will instantiate one or more properties of the associated Resources to achieve a defined Outcome pattern for an approved>SalesOrder.

Undertakings are:
a) enabledBy a transaction (triggered by the achievement of pre-conditions for a particular Context of the associated Resources);
b) invokedBy an interaction (invoked by an expression of Intent from a Role);

Rules that control the logic for the transition of attribute states in an Undertaking and the constraints on attribute states for its associated Outcome are expressed as Conditions. The Undertaking evaluates the logic of Conditions against the respective pre-conditions (Context) and post-conditions (Outcome) for the associated Resources.

Intent 116 (Intent proposedBy a Role),

Many business endeavours involve interactions with external agents. An interaction provides an opportunity for an external agent (or Role) to provide an input to the endeavour. This input is an expression of the agent's intent.

Intent can be either inbound or outbound. Inbound intent represents an invocation of an Undertaking by an agent. Outbound intent is a request to an agent for a response. Both could include a payload of information that is relevant to the interaction

Intent is proposedBy (inbound) or proposedTo (outbound) a Role. Intent is authorisedBy the Entitlement terms associated with the Role. For example an approval of a pricing discount invoked by a manager Role would be authorised against the discount Entitlements that the Role is authorised to approve.

Entitlement 117 (Roles are grantedBy Entitlements)

Through their association with Roles, agent Resources participating in an Undertaking are granted Entitlements. Entitlements are designated policies that govern:
Permissions (defines the type of Resource that can fulfil a Role)
Authorisation (constrains the type of Intent that a Role can express)

Entitlements (as all governance constructs) are expressed as axiomatic facts. A Permission is a statement about a property that needs to be satisfied by the properties of a Resource in order to capacitate it with a Role (e.g., jobLevel >=4).

An Authorisation is a statement about a property that needs to be satisfied by the property values of the Intent that a Role is proposing or being proposed (e.g., authorisedDiscountLevel <=20%).

Condition 118 (Undertakings are controlledBy Conditions)

Conditions are functions that regulate Behaviour. Based on the contextual states of the Resources participating in an Undertaking, Conditions represent the logic that determines the proposed change of state of Resource attributes in the achievement of Outcomes. Many Rules in an organisation are based on evaluations of temporal states. An Undertaking will consider the current states of Resource instances and the associated proposition of Intent to validate these against predefined Conditions.

Entitlements may also be arbitratedBy Conditions, so that the authorities granted to a Role may vary under different state based circumstances. Terms in the Condition logic will be formulatedOn Compliance propositions governing valid states for Resource instances.

Compliance 119 (Resources are constrainedBy Compliance),

The Compliance cell contains business specific assertions stated as axioms (logical statements that are required to be true). Compliance assertions constrain the material properties an instantiated Resource can obtain. In other words, the possible value ranges for properties of a Resource instance are constrained by Compliance propositions.

FIG. 2 provides an elaboration of the multiple rich relationships which bind the nine base constructs. These relationships form the basis for the CAPSICUM analysis method described below.

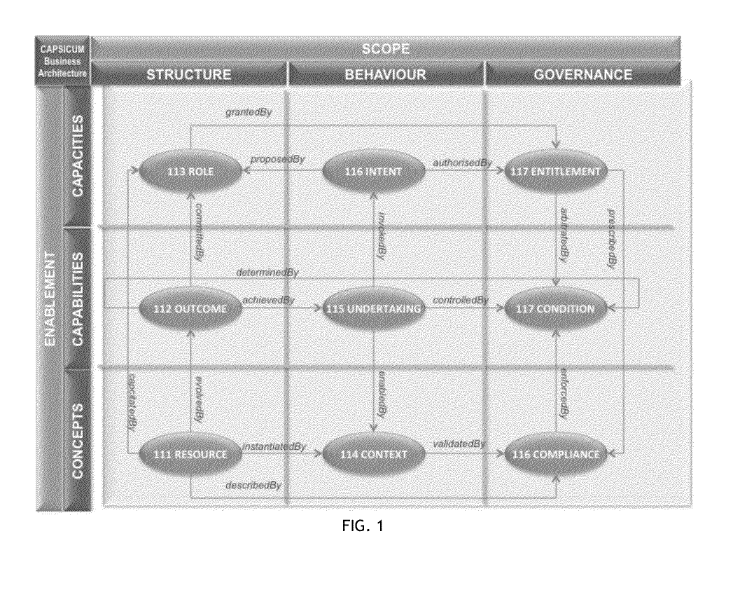

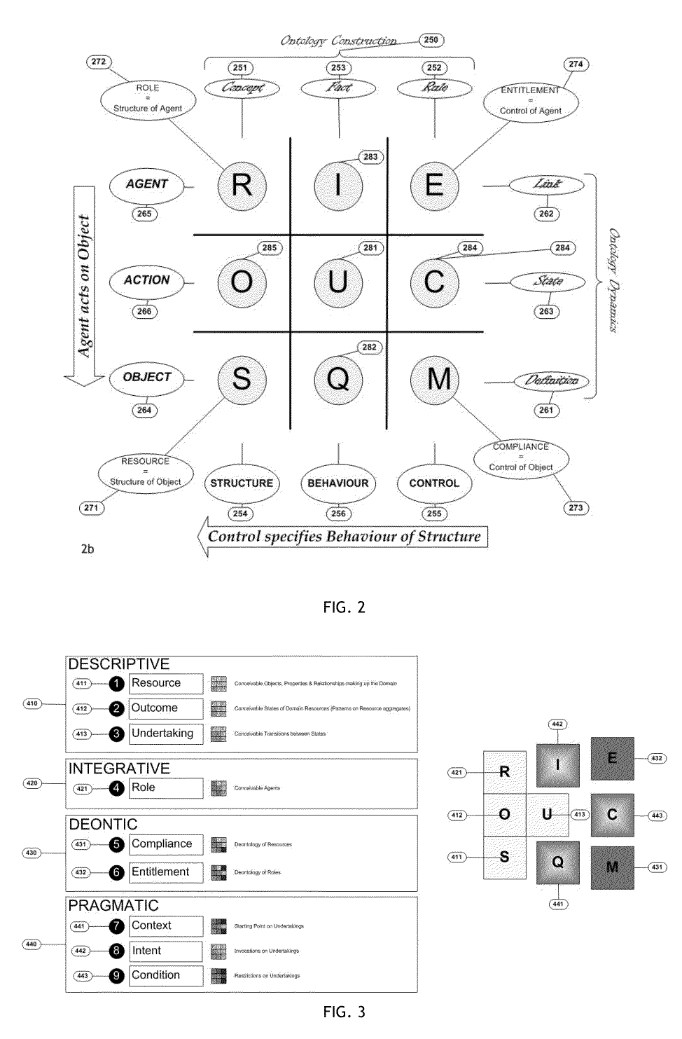

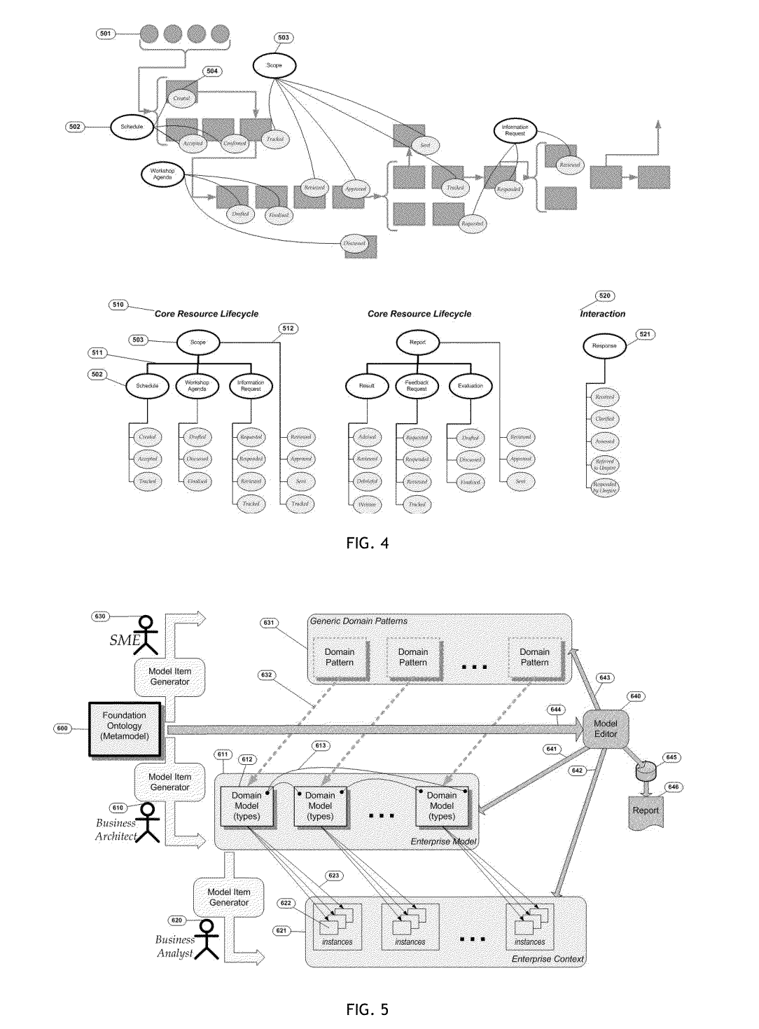

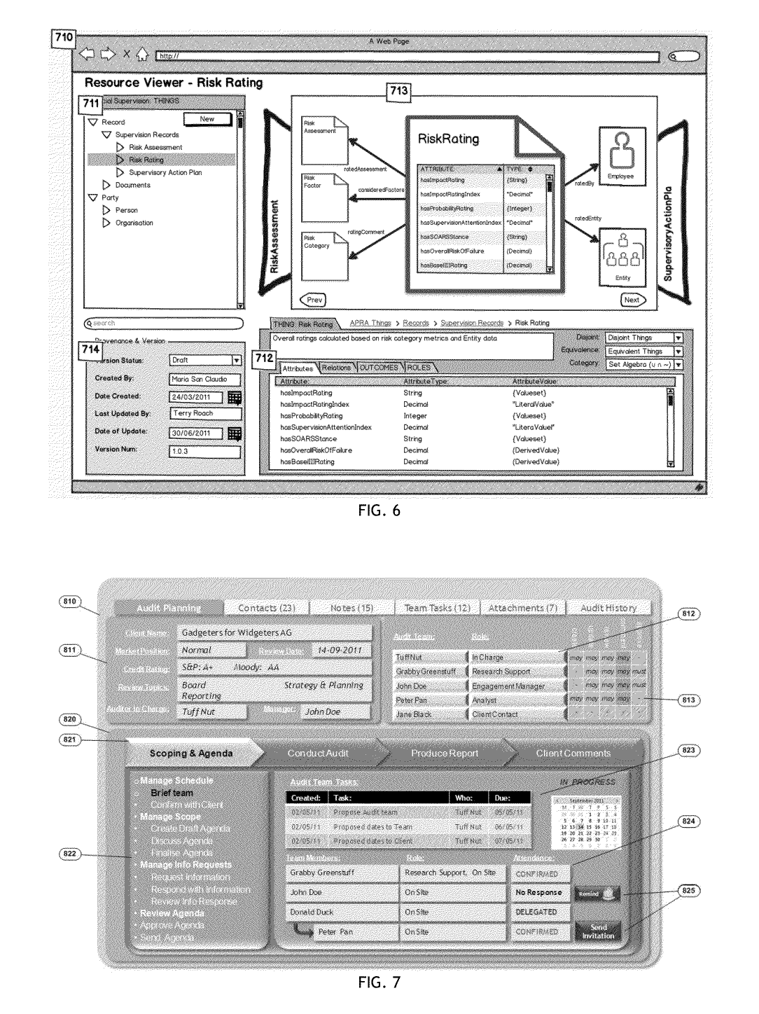

FIG. 3 describes the phases of the Discovery Method for the elaboration of a Description of a business endeavour. As illustrated, the definition of a domain proceeds in four stages, each with specific methodological characteristics.
1. In the Descriptive stage 410 the analyst discovers all the elements which constitute the functional profile of the domain, beginning with
   a. Resources 411: the analyst inventories all conceivable Objects, Attributes a Relations making up the Domain. Resources frame the second step:
   b. Outcomes 412: for each resource, the analyst discovers its lifecycle, consisting of the conceivable states of the resource, specified by some of its Attributes and Relations. Outcomes are configuration patterns defined on types, domains and ranges of Resource properties. In turn, the transitions between states lead to discovering:
   c. Undertakings 413: the analyst defines the kinds of work (activity) necessary and sufficient to effect each transition. Undertakings are transformation patterns which map an input configuration to an outcome. They implicitly specify which state transitions can be effected and explicitly state the logic by which state transitions are effected.
2. In the Integrative stage 420 the analyst focuses on the relationships between parties to the domain. These are embodied in
   a. Roles 421 which specify the ways in which capacitated Resources interact in the operation of the domain. Roles appear as actors, or agents, although each is specific to a particular kind of interaction, identified by application of the principle of loose coupling.
3. In the Deontic stage 430 the analyst focuses on the rules that distinguish the individual character of a particular business endeavour from the general features of endeavours in the same domain (e.g., the specifics of ABC Insurance as against the general definition of an insurance company). There are two main classes of deontic specifications:
   a. Compliance 431 specifies the parameters applicable to the properties of Resources, that is establishes possible values, value ranges and cardinalities of the attributes and relations of the objects making up the domain, in the various states of their lifecycles.
   b. Entitlement 432 establishes the ways in which Role definitions capacitate Resources to participate in the business endeavour.
4. In the Pragmatic stage 440 the analyst derives the pragmatic implications of the impact of the Deontic specifications on the Descriptive and Integrative stages. It will be noted that this stage concerns itself primarily with instances, while the preceding ones dealt with types.
   a. Context 441 represents the state of affairs in the domain at any point in time. It is made up of all the resources instances and their (instance-level) relations and attributes. These instances reflect both the descriptive Resource classifications and the Compliance constraints.
   b. Intent 442 similarly represents the possible instances of interactions with capacitated parties to the endeavour. Such Intents control the authorised behaviour of Roles filtered by the assignments of Entitlements.
   c. Condition 443 controls the execution of an Undertaking, jointly entailed by Compliance and Entitlements. In other words, Conditions only allow, in response to Intents aligned with Entitlements, instances of Undertakings which will produce Outcome instances aligned with Compliance.

FIG. 5 illustrates by way of example the manner in which the constructs described above can be discovered. The top part of the drawing represents a method of analysis applied to existing business documents, exemplified here by a Business Process Diagram 501 shaded in gray. For each step in the process, the analyst identifies a candidate Resource S which is being affected by the process step. Some sample identified Resource candidates are shown as heavy outline ovals (502, 503). Also each process step introduces a specific state of resource S, shown as light outline ovals (504). As the analyst follows through the process steps, possible states of resource S will be inventoried. As resource S may participate in several business processes (as represented in the traditional fashion) the whole definition of the lifecycle of resource S will be progressively filled in as more processes are examined. It is important to note that some such processes may not be wholly contained within the domain of interest, and therefore some states of the lifecycle of S may only appear as cross-domain processes are investigated. This observation shows up one of the great advantages of this invention, namely, that it provides a natural way of understanding the full lifecycle of business objects, independently of any particular ways of “doing” the business. In other words, resources and their lifecycles are an invariant of the endeavour: they are not affected by choices of tactics.

The bottom part of the drawing reflects this fact. Each core resource 510 is represented with its states appended. It will be noticed that a given resource may be a composite 503, with each component resource 502 having its own lifecycle. As the composite resource is being constructed 511, its lifecycle is the composition of the components' lifecycles. However, it may also have further states 512 as a completed whole.

There are also resources 521 which are not enduring objects, but rather track some forms of interaction 520 (with other domains or with the wider world). While such resources would not normally be persisted in operational systems, it is common practice and good governance to keep them as records. The simple common representation as lifecycle supports this practice implicitly.

Turning to FIG. 6, it will be seen how the foundation ontology 600 can be embedded in a computer program product which supports several phases of the business analysis and business design work.

The primary mode of usage of the product is in the creation of an Enterprise business model 611, made up of domain models 612 for which the foundation ontology is a metamodel. The need for logical consistency imposes limitations on the expressive power of semantic models. Because of these limitations, it is not possible to consider the enterprise model elements to be instances of the foundation elements. This would prevent them being used as classes for instantiation into an enterprise context.

Accordingly, the product “Model Item Generator”, as used by the Business Architect 610, creates templates as appropriate to define model elements as specified by the metamodel in the foundation ontology for each of the kinds of elements (Resource, Outcome, Role, etc.). In the model ontology, these elements are not declared as instances of the foundation elements. Instead they are related to the foundation ontology by a distinct property, the logic of which is defined by adequate inference rules that do not cause inconsistency. A model editor 640 supports the provisioning 641 of the created templates, provides guidance on the appropriate way to fill them, verifies consistency 644 with the foundation, and records 645 the state of completion of each definition. At any time, the analyst may request a report 646 on the current state of the model. The specifications left incomplete are highlighted and serve as prompt for further elicitation.

A secondary usage of the product is to support a Business Analyst in the creation 620 and editing 642 of the actual instances 622 within an Enterprise Context 621. In this case, the instances are related 623 to the model types in the normal way (rdf:type).

Finally, the creation of domain models can be greatly facilitated and speeded up 632 by the supply of standard domain patterns 631, which represent the generic knowledge of such domain as shared by Subject-matter experts (SMEs) 630. When such patterns are available, the Business Architect can use them as the initial draft of the model, and use the model editor 641 to adjust it.

FIG. 7 shows some an example of how the user interface of the computer product described in FIG. 6 can display the information captured in the model, as an aid to editing as well as an alternative to a printed report on the state of the model. Various representations of the ontology Concepts are illustrated in trees, tables and graphical form 710. The Resource Navigator 711 classifies the selected ontology item within a Resource taxonomy. The Resource inspector 712 presents the detailed characteristic properties of the resource in a tabular form. The Resource Graph 713 represents the same information in a graph format. The versioning and provenance information for ontology governance is shown in 714.

The bottom part 720 illustrates a purely graphic representation. The resources 721 and their properties 722 are represented as introduced in FIG. 5. Further, the relationships between resources are represented by dotted lines 723. This visualisation provides a better gestalt perception of the core features of the domain.

FIG. 8 shows another sample of a user interface designed to reflect the execution of Capabilities components of model constructed according to the invention. The real estate of the screen is divided into two main regions.

The top region 810 holds reference information about the related party Resources:
a. the subject Resource 811 in focus, including its relevant attributes
b. the Roles 812 which intervene in the actions of interest
c. the Entitlements 813 relating these Roles to the actions of interest

The bottom region 820 manages the details of recording the Outcomes of the Capability:
a. at the top a “value chain” 821 shows the dependencies among high-level Undertakings
b. the left-hand pane 822 lists the possible states of the current object Resource
c. the top-right pane 823 shows the current state of the current object Resource
d. the bottom-right pane 824 shows the detail of the current state, including buttons for Intents 825 to launch possible next Undertakings.

What is claimed is:

1. A method for using a foundation ontology as a means to drive the recording and modelling of business enterprise knowledge, comprising:
identifying and delimiting a domain of business activity;
identifying and defining the main resource(s) in that domain;
defining the lifecycle of identified resources;
identifying and defining auxiliary resources needed to support the main resources;
defining the lifecycles of the auxiliary resources;
for each defined resource, identifying and defining the possible state transitions in its lifecycle;
associating to each state transition one or more kinds of actions (undertakings) which may achieve the transition;
when appropriate, associating with each undertaking one or more kinds of agent (roles) capacitated to effect the undertaking; and
formulating the findings in the proper formal language.

2. The method of claim 1, wherein the business enterprise knowledge is obtained from mining previously existing documents in a variety of formats, scopes and purports.

3. The method of claim 1, wherein the business enterprise knowledge is obtained from collaboration with Subject Matter Experts.

4. The method of claim 1, wherein the business enterprise knowledge relates to the governance of objects, their attributes and their relations.

5. The method of claim 1, wherein the business enterprise knowledge relates to the governance of assignment of permissions and authorisations of actions.

6. The method of claim 1, further comprising:
incorporating semantic tags which identify the sources of the business enterprise knowledge to support traceability

7. The method of claim 1, further comprising:
using incorporated semantic tags to produce traceability and/or reliability reports

8. The method of claim 1, further comprising:
confirming the internal logical consistency of the findings; and
validating the conformance of the findings to the foundation ontology.

9. A system for using a foundation ontology as a means to drive the recording and modelling of business enterprise knowledge, comprising:
a host system;
a storage device to contain the foundation ontology;
one or more storage devices to contain the models constructed under the guidance of the foundation ontology;
a domain definition application executing on the host system, including computer instructions for performing:
receiving a request for creating a new domain model;
preparing the framework for recording the elements of the domain model (model items); and
a model item generator application executing on the host system, including computer instructions for performing:
receiving a request for creating a new model item type of a given foundation category;
producing a form for said item type under the guidance of the foundation ontology;
receiving definition details for the new item type;
incorporating received information in the domain model.

10. The system of claim 9, further comprising:
a domain model verification application executing on the host system, including computer instructions for performing:
confirming the internal logical consistency of the findings; and
validating the conformance of the findings to the foundation ontology.

11. The system of claim 10, further comprising:
a domain model visualisation application executing on the host system, including computer instructions for performing:
presenting the internal structure of a domain model as stored in its storage device; and
producing a variety of graphic representation of selected portions of a domain model.

12. The system of claim 10, further comprising:
a domain model traceability application executing on the host system, including computer instructions for performing:
recording the original source of information using semantic tags; and
producing a traceability report of the tagged source information.

13. The system of claim 11, further comprising:
a domain model traceability visualisation application executing on the host system, including computer instructions for performing:
retrieving the original source of information presented; and
producing a representation of the retrieved source information.

14. A computer program product for using a foundation ontology as a means to drive the recording and modelling of business enterprise knowledge, comprising:
a storage medium readable by a processing circuit and storing instructions for execution by the processing circuit for implementing a method, the method comprising:
receiving a request for creating a new domain model;
preparing the framework for recording the elements of the domain model (model items); and
receiving a request for creating a new model item type of a given foundation category;
producing a form for said item type under the guidance of the foundation ontology;
receiving definition details for the new item type;
incorporating received information in the domain model;
confirming the internal logical consistency of the findings;
validating the conformance of the findings to the foundation ontology;
recording the original source of information using semantic tags;
producing a traceability report of the tagged source information;
presenting the internal structure of a domain model as stored in its storage device;
producing a variety of graphic representation of selected portions of a domain model;
retrieving the original source of information presented; and
producing a representation of the retrieved source information.

15. A method for deriving specifications for automated information services from a Business Architecture elaborated and formalised by means of the invention.
